(19) United States
(12) Patent Application Publication
(10) Pub. No.: US 2013/0111971 A1
(43) Pub. Date: May 9, 2013

(54) Sensor

(71) Applicant: Marko PUDAS, Espoo (FI)

(72) Inventor: Marko PUDAS, Espoo (FI)

(21) Appl. No.: 13/664,980

(22) Filed: Oct. 31, 2012

(30) Foreign Application Priority Data
Nov. 3, 2011 (FI) FI20116082

(51) Int. Cl. G01P 15/00

(52) U.S. Cl. 73/12.01

(57) ABSTRACT

A sensor structure includes a mass element (104, 204) and a support element (106, 206) for the mass element, either or both of the elements including carbon nanostructures (106, 114, 206) at least some of which are mutually non-parallel, the mass element and support element being configured such that upon acceleration or other mechanical or energy impact exceeding a predetermined threshold, a permanent change takes place in the physical configuration of the carbon nanostructures and in a dependent, measurable value of a predetermined electrical parameter, the electrical parameter optionally including or indicating at least one electrical property selected from the group consisting of: resistance, inductance, capacitance and impedance.

### FIELD OF THE INVENTION

Generally the present invention pertains to sensors. In particular, however not exclusively, embodiments of the present invention concern impact and acceleration sensors advantageously capable of fuse-like performance, wherein the permanent change in measurable value occurs over the influence of external factors.

### BACKGROUND

Product storage, transport and use conditions are of general concern regarding e.g. different liability and product warranty issues in various fields of trade and technology, such as medical equipment, for example. Monitoring of conditions such as temperature, humidity, radiation, speed and acceleration may be nowadays executed using available data gathering solutions typically incorporating a number of application-specific sensors, data processing equipment, data storage facilities and data transfer gear. From the purely technical standpoint data acquisition and transmission is thus not an especially complex task anymore as more powerful and precise technologies pop up in the market every now and then.

However, in terms of costs, size and data verification, the contemporary solutions are far from perfect, if considered even adequate in the first place. Namely, adding current condition monitoring equipment to target objects is both too expensive and space-consuming particularly in case the only purpose thereof is to measure and store indications of predetermined conditions of the object for future evaluation in connection with product warranty-related disputes, for example. Thus far, a conventional solution has been an employment of accelerometers and an active monitoring thereof. However, solution of the kind enabled an impact indication only in condition that the system is powered on. Secondly, with the present solutions the actual verification of condition monitoring data may be tricky as computer-based data storage arrangements and data associated therewith can be rather easily tampered with, whereupon questioning the validity of such data is in many scenarios somewhat justified. Glass capillaries that are configured to break upon an impact of predetermined intensity may be utilized for detecting and particularly substantiating afterwards an occurrence of such incident, but they are typically large and clumsy, costly and omit electrical readability, which is also a major defect in modern day's electric society and environment.

Patent publication US 2007/085156 discloses acceleration and voltage measurement sensor device configured as an on-switch for closed circuitry and provided with a densifled carbon nanotube layer solvent dispersed onto a physical support. The sensor device comprises a conductive layer placed underneath the nanotube layer by and utilized for attracting and holding the latter by van der Waals forces. The technology does not imply sensing of other external forces, such as radiation-, magnetic- or other energy impacts.

Current acceleration and impact sensors are most often inertial sensors such as accelerometers based on a damped mass on the spring system, wherein mechanical motion of the mass subjected to acceleration or impact (shock) is converted into a representative electrical signal to be processed and stored by available processing and data storage means, respectively.

### SUMMARY OF THE INVENTION

The objective is to at least alleviate one or more aforesaid problems and to provide a sensor solution feasible for use in applications requiring reliable and verifiable detection of acceleration and related shocks caused by drops or other energy impacts, for example.

The objective is achieved by different embodiments of a sensor structure in accordance with the present invention.

In one aspect of the present invention, a sensor structure is provided, which sensor structure may be utilized in detection of acceleration, such as shock, and comprises:
a mass element and
a support element for the mass element, said support element comprising nanostructures, preferably substantially tubular nanostructures, more preferably nanotubes, and still more preferably carbon nanotubes (CNTs), wherein at least some of the nanostructures such as nanotubes are specially manufactured to be mutually non-parallel for required properties,

the mass element and the support element being configured such that upon acceleration and/or other mechanical, radiation-, magnetic- or other energy impact, exceeding a predetermined threshold, a permanent change takes place in the physical arrangement of the nanostructure arrangement inducing a preferably permanent change in a corresponding measurable value, which value may be dependent on configuration of the sensor structure.

By the expression of “permanent change” one should herein understand a physical damage of the support element such as altering, fracturing or breaking, to a condition that it is not able to conduct electrical signal anymore.

In one embodiment, the support element comprises a film for accommodating the mass element. The film may consist of or be at least provided with the nanostructures, preferably tubular nanostructures, such as nanotubes, preferably carbon nanotubes. The film is preferably free-standing in the surrounding medium, e.g. air, other gas, liquid, generally fluid or vacuum, and advantageously omits a separate substrate. The film may still be supported by and/or fixed from the selected portions such as selected edge portions to a number of electrical connectors or further supporting and/or fixing element(s) such as a casing or body of the sensor. Further supporting and/or fixing element(s) may thus be either single- or multi-portion or multi-part elements and may be referred as “carrier” element(s) further in this disclosure.

The film may be substantially formed from non-tubular materials, e.g. sheet(s), such as sheet(s) of graphene. Mechanical and electrical properties of a graphene film are substantially the same as for the thicker nanotube-comprising film.

When the sensor structure and the included mass element are subjected to a force due to e.g. acceleration, such as shock-type sudden acceleration (or deceleration), the mass element will induce additional pressure onto the film, whereupon the film will reshape, i.e. stretch, which changes its electrical response regarding the parameter measured. When the stress induced on the film is great enough, i.e. over a predetermined threshold, the film may fracture or otherwise break, whereupon the measurable electrical response changes more radically and such tear may be easily identified accordingly, for example by visual detection within suitable packages and parts thereof.

In one substantially supplementary embodiment the sensor structure may comprise a number of mass elements 106.

In another, substantially supplementary embodiment, the film comprises a number of predetermined fracture-affecting features such as fracture points, areas or volumes configured to enable at least partially controlled, facilitated fracturing of the film due to the mass element-induced, structural limit exceeding stress in the film. These fracture-facilitating features may include at least one element selected from the group consisting of: a crack defined by the film material, a slot defined by the film material, a hole or recess defined by the film material, a protrusion defined by the film material, a thinned portion of the film, a varying number of film layers in multilayered structures, a physical or chemical change in certain spot defined by film material caused by modified mechanical properties, a narrowing of the film, and a cut defined by the film material.

In accordance with the aforesaid embodiments, the mass element is adapted to cause a mechanical and/or physical modifications in the support element by introducing an external force thereupon, thus inducing measurable changes in the film. An external force may be also represented by radiation, such as high intensity light, or by a high magnetic field in case of utilizing a ferromagnetic mass.

In a further embodiment, the carrier element comprises at least a partial shell structure, such as a spherical shell, from the inner surface of which tubular nanostructures are configured to extend substantially towards the center portion e.g. forming a nanotube forest. The center portion preferably comprises the mass element, such as a spherical mass element, supported by the carbon nanotubes. Again, upon acceleration exceeding a predetermined threshold, the mass element causes permanent changes in its environment by inducing forces and stress to the nanotubes that may, in response, collapse and/or otherwise reconfigure. The measurable electrical response then changes as well.

Alternatively or additionally, the nanotubes may be grown on the mass element surface.

In various aforesaid or other embodiments, a number of electrodes and/or other sensing elements may be electrically or optically coupled to the support and/or carrier elements structures, optionally disposed thereon or therein, for measuring the value of the electrical parameters by a measuring circuit.

In various aforesaid or other embodiments, the electrical parameter may include or indicate at least one electrical property selected from the group consisting of: resistance, impedance, capacitance and inductance.

In various aforesaid or other embodiments, the sensor structure may comprise a separate device for measurement of optical parameters, which optical parameters may include or indicate at least one optical property selected from the group consisting of: reflectance, absorbance, change of absorber or reflected frequency, change in place of reflection, measured change in absorption of transmitted or reflected radiation. Said optical parameters may be measured with external or internal components, which are otherwise relate to common prior art and therefore are not disclosed herein.

In various above or other embodiments, acceleration remaining below or at the threshold may cause permanent modifications in the sensor structure, that modifications may be monitored as changes in the readout value of the components.

In various aforesaid or other embodiments, data storage such as a memory chip may be applied for storing indication of the threshold-exceeding incident and/or other data measured and/or derived from measurement data.

In various aforesaid or other embodiments, an alarm such as an alarm signal or a corresponding indication may be triggered responsive to the detection of threshold-exceeding incident, which may optionally include data transfer towards an external entity such as a remote control station or server.

In various aforesaid or other embodiments, after a predetermined number of threshold-exceeding incidents and preferably in response thereto, a predetermined action may be taken optionally including a corrective, a damage minimizing and/or a compensative action from the standpoint of the incident.

For example, when the sensor structure is embedded in or connected to an electronic apparatus comprising a fragile element such as a hard disk, the hard disk may be parked to minimize (further) damages thereto. Thus, subsequent startups of (partly) damaged electronic apparatus may not be allowed. Alternatively, if the structure is utilized in connection with a logistic container so that the maximum physical shocks the container had experienced during transportation may be indicated by any suitable way at a check-out, e.g. wirelessly, then an active dampening thereof may be adjusted in response to the detection of a severe bump, i.e. shock, during transportation.

By way of example, a method for manufacturing a sensor structure for detecting acceleration may comprise
obtaining a mass element,
obtaining a support element for the mass element, which comprises nanostructures, preferably tubular nanostructures, more preferably nanotubes and still more preferably, carbon nanotubes, at least some of which are mutually non-parallel and/or randomly arranged and are capable of forming a free-standing film structure,
obtaining at least one connector, such as an electrical connector (e.g. electrode) or an optical connector, for connecting an above mentioned support element thereto, wherein the transitional disposition of said support element related to the connector(s) and the number of connectors are preferably defined by technical implementation requirements, design, and application of a particular sensor structure, and
configuring the mass element and support element such that upon acceleration exceeding a predetermined threshold, a permanent change occurs in the physical configuration of the nanostructures, such as carbon nanotubes, for example, also resulting in a measurable change in the value of a dependent predetermined electrical parameter.

The utility of the present invention arises from multiple issues depending on the particular embodiment in question. First of all, acceleration and related incidents such as drops, shocks, impacts etc. may be reliably detected. Second, the authenticity of an incident causing the permanent change may be later verified by analysis of the stored data and/or the induced physical reconfiguration such as a breakage of the support element, e.g. nanomaterial fracture. Namely, a permanent change takes place in the physical configuration of the carbon nanotubes due to the forces exerted thereto by the mass element and/or the free-standing film. In some embodiments, a carbon nanotube film with unoriented carbon nanotubes (at least non-parallel nanotubes) may be constructed from the nanotubes excluding additional substrates, which simplifies the manufacturing and the resulting structure. Yet, the film sensitivity to acceleration remains excellent. Furthermore, the sensor structure can be configured to detect exceeding values of radiation flux or fluid flow.

The sensor structure may be connected to or included in various target objects such as logistic containers or electronic appliances, e.g. consumer electronics including batteries, cell phones, smart phones, tablet PCs, PDAs, laptops, computers and the like, sensitive to acceleration. Thereby, target object integrity may be monitored, self-checks made, related flaws in structure and/or functioning detected, and the occurrence of at least a severe incident verified afterwards. The obtainable sensor structure may be both small in size and affordable. The sensor structure may be utilized in Electric Vehicles (EVs) as a fuse, which cuts power from an energy supply (e.g. a battery) on an impact, such as car crash.

The sensor structure of any embodiment can be connected to a wireless readout device, such as RFID, for example, and respectively to be utilized in RFID tags, such as RFID stickers and the like.

In contrast to e.g. metal films, the nanofilm of the present invention is typically scalable down to nanometer scale in terms of thickness, while the sensitivity increases respectively. Most implementations of the spherical-type embodiment will also scale down at least to micrometer scale. Further, nanotube- or graphene-based sensor structure may be manufactured to neither be influenced by reflow soldering temperatures nor by magnetic or −RF-fields. As a substantially beneficial feature of the nanotube film-based structure, its resistance property in a range of 1 kOhm may be indicated, that enables a direct connection of said structure to e.g. a microcontroller.

The sensor structure with a fuse-like performance, in accordance with some embodiments of present invention, may be manufactured utilizing a conducting or semiconducting film, such as a metal film, for example, which film accommodates the mass element so, that upon a sufficiently high acceleration the mass element may cause the damage of the film thus cutting the conducting path.

The term “nanotube” refers herein to tubular nanostructures of any kind, suitable for a freestanding film construction. Said tubular nanostructures may preferably comprise carbon; however, e.g. silicon- or carbon- and silicon-containing nanotubes (SiCNTs), metals- and/or other elements containing tubular nanostructures may be utilized. In addition, graphene and any suitable solid or amorphous matter capable of forming a free-standing film in accordance with embodiments disclosed herein may be utilized. Said film may additionally comprise other materials, like particles, for example metal particles or other elements.

The term “fuse-like performance” or “fuse” refers herein to an ability of the sensor structure in accordance with some embodiment of the invention to become permanently modified upon being affected by exceeding amount of mechanical, radiation-, magneticor other energy. For example, in case an exemplary resistance of the sensor structure in its average, unaffected condition is 1 kOhm, then this value may change to 2 kOhm upon subjecting said structure to a stress. However, the resistance value of once subjected to a stress sensor structure does not return back to average, i.e. changes in said electric property are permanent, in condition that the stress is for example in the range of 10-90% of load threshold value for above mentioned film, and correspondingly in the same range of breaking limit for the sensor structure. It should be understood that in case of permanent mechanical damage of the film, such as breakage, the resistance between electrodes significantly increases, generally to a value greater than 1 MOhm, which is indicative of a fact, that resistance of the sensor is mostly affected by the nature of dielectric material and external conductor paths.

The terms “glue” or “gluing agent” refer in this disclosure to any solid, amorphous, liquid or other material deposited or otherwise patterned in similar manner to one or all surfaces, and the term “to glue” refers herein to a deposition and/patterning method, respectively, which deposition method may be represented by, but not be limited with, conventional adhesion techniques as well as by semiconductor industry manufacturing methods, such as sputtering, Atomic Layer Deposition (ALD) or Chemical Vapor Deposition (CVD), for example.

The expression “a number of refers herein to any positive integer starting from one (1), e.g. to one, two, or three.

The expression “a plurality of refers herein to any positive integer starting from two (2), e.g. to two, three, or four.

The terms “a” and “an”, as used herein, are defined as one or more than one.

The terms “acceleration” and “deceleration” may be used in the context of the present invention interchangeably.

Different embodiments of the present invention are disclosed in the dependent claims.

### BRIEF DESCRIPTION OF THE RELATED DRAWINGS

Next the invention is described in more detail with reference to the appended drawings in which

FIGS. 1A and B illustrate one embodiment of the suggested sensor structure and its variations.

FIG. 2 illustrates one other embodiment of the suggested sensor structure and its variations.

### DETAILED DESCRIPTION OF THE EMBODIMENTS

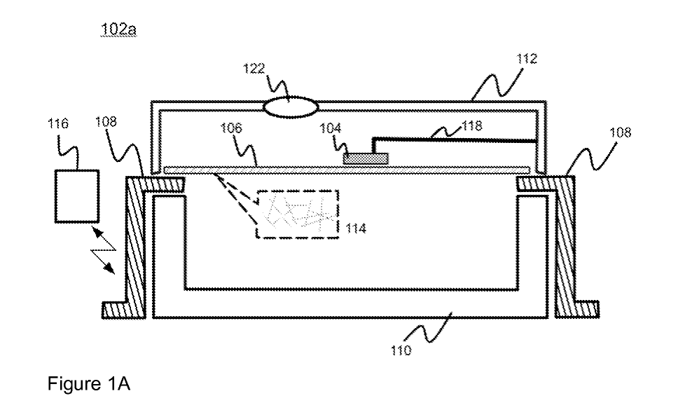

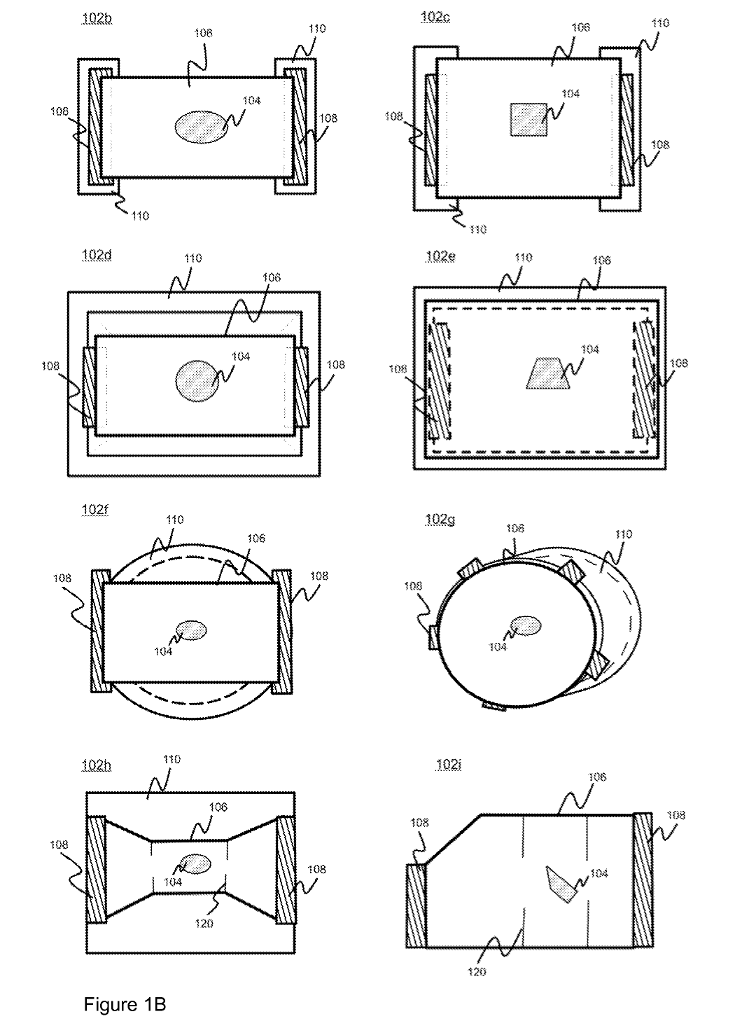

FIG. 1A discloses at 102a, representing a cross-sectional side view, an exemplary embodiment of the sensor structure feasible for coupling to or even inclusion in a target object such as an electronic device or a logistic container.

The support element in the form of a nanotube film, preferably a CNT freestanding film 106 is functionally coupled to the electric conductors 108, such as electrodes, from the edges or edge areas along the whole circumference or at least from a number of selected points such as two optionally opposing points in such a way, that the film 106 is suspended in the air or any other medium in between two electrodes. Preferably two electrical connections are utilized; however, at least one electrical connection ought to be present. Optical connectors, such as optical wave guides, may be utilized as well. Said electrodes are in turn being supported by carrier element(s) 110 Carrier elements 110 may be provided by casing, body, frame or other supportive and/or otherwise protecting part of the sensor structure.

The film 106 may be substantially formed from non-tubular materials, e.g. sheet(s), such as sheet(s) of graphene. The sheet-like structure may comprise a single layer or a number of layers.

It is to be understood, that a number of electrical conductors is not limited by two disclosed. The form and shape of the sensor structure 102a disclosed herein are merely exemplary and are supposed to provide a general understanding to those skilled in art of sensor's operation. In condition that above mentioned freestanding film 106 is disposed in space between at least two carrier elements 110, or disposed in space over carrier element realized as a frame of any shape, and that said film is coupled to at least one electrical conductor, the configuration of the sensor structure may vary depending on various implementation- and application-related factors.

The film 106 may be thus either fixed on electrodes 108 e.g. by adhesive or solder, or may be bound thereto directly during sensor structure manufacturing process, without any additional substances. A mass element 104, configured as a physical weight, is located on the film 106 as centered thereon or otherwise disposed. It may be likewise secured to the film 106 by gluing, for instance, or may be bound thereto directly during sensor structure manufacturing process without any additional adhesives. Thus the film 106 acts as a support element for the mass element 104. The mass element 104 may further be of a predetermined size and shape. For instance, substantially spherical shape may be utilized. A proper mass element may be determined on the basis of film durability and sensor sensibility among other options defined specifically by the application.

Further on, the mass element 104 may be deposited onto the film 106 in the form other than solid matter, for example as fluid, solidifying upon its deposition. Still certainly depending on the actual thickness, the film 106 may be often substantially considered as a two-dimensional object.

Adhesion of the mass element 104 to the film 106 may be realized spontaneously, by van der Waals forces. Alternatively or additionally the mass element may be physically bound to the film 106 by gluing, for example. Advantageously silicon glue can be used, which withstands soldering temperatures upon final assembling of the sensor structure. Gluing may also be performed by targeted or conformal deposition of additional material.

The film or the CNT forest structure may be further modified by applying any material and/or substance thereto and removing any material and/or substance therefrom to effestively change mechanical performance and/or to act as a gluing agent with regards to other parts like connectors, such as electrodes or optical wave guides, and/or to the mass element (e.g. while fixing 104 to 106).

The mass element 104 may also be positioned at least partially inside the film 106, set up through the film 106 or wrapped around the film 106.

In accordance to one substantially supplementary embodiment the sensor structure may comprise a number of the mass elements 104.

Mass element(s) 104 may be deposited onto the film 106 by being positioned between layers of the sheet-like structure of the film 106, in accordance to some embodiment. Said layers may therefore be adhered to each other spontaneously by van der Waals forces, or alternatively may be glued, as mentioned above. Said layers may be also physically wrapped around electrodes 108. Electrodes 108 in this case may be provided as extending out of a frame of the carrier element 110, as an alternative of being placed onto the edge of a frame of the carrier element 110, for example. A benefit of such an arrangement is that the film 106 is not compressed during manufacturing process.

Mechanical properties of the support element 106 in the form of the free standing film may be modified whether required by e.g. by material deposition methods. Material deposition technology can be utilized for both material exchange and for only changing physical properties of the film 106. The film 106 may thus be modified by coating techniques, for example, which coating can be applied onto any surface of said film.

The mass element 104 may also be coated to change its mechanical properties and/or to achieve a required adhesion. Coating material may also act as gluing agent to glue the mass element 104 to the film 106 and possibly to electrodes 108.

Coating may be applied by methods of physical and chemical deposition similar to those used in semiconductor industry, such as sputtering, Atomic Layer Deposition (ALD), Chemical Vapor Deposition (CVD), PVD (Physical Vapour Deposition) and the like. Alternatively material coating may be performed by at least one from the following procedures: mechanical dispensing deposition of the (coating) material onto the film 106; dispensing the film 106 onto the material to be deposited with; immersing the film 106 into the material to be deposited with; chemical deposition (such as chemical reaction or sedimentation) from liquid or gas onto one or several parts of the structure being coated.

Similarly, the film 106 may be etched or, generally speaking, undergo a process when mechanical strength of the film is decreased. Most effective realization of this process may be attained by eroding the film with oxygen (O₂) or ozone (O₃) treatment, for example, wherein ozone treatment is generally implemented at lower temperatures in comparison to oxygen treatment. It is advantageous to enable ozone treatment just prior sealing the casing of the sensor structure. The casing may be represented e.g. by carrier element(s), as disclosed elsewhere in this document. Other methods for reducing mechanical strength of the film 106 may comprise treatment of said film by corroding or oxidizing agents, such as acids.

The bubble 114 depicts the orientation of the nanotubes (lines in the bubble) in a free-standing film. The arrangement of said nanotubes is preferably random and the orientation is mutually non-parallel. A number of electric conductors such as electrodes 108 are at least functionally coupled to the film for sensing a number of predetermined electrical parameters. e.g. resistance. A number of coupling points may be located at the film edges and/or at other desired locations. A cover element 112 may cover and protect the selected portions of the sensor structure from physical contact to the environment and dirt, for example, and facilitate disposition thereof to a target location inside a target object. An aperture, wherein an optical element 122, such as e.g. lens, is disposed, may be arranged in the cover 112 for visual monitoring of the mass element 104 location and for performing other functions disclosed further. The optical element may be represented by window and comprise optically substantially transparent material relative to a number of predetermined wavelengths, such as the wavelengths of visible light. Optionally the cover 112 and/or the carrier element 110 are integral or removable parts of the target object such as a delivery container or an electronic apparatus. Optionally the mass element 104 may be permanently attached to the cover 112 by an elastic or plastic connection, such as a cantilever, a wire or a spring 118, in order to limit the force or a degree of motional freedom of 104. An above mentioned coating material may be utilized as a gluing agent to glue the mass element 104 to the support element 106 and possibly to electrodes 108 or elements 110, 112, wherein the latter elements generally form a package or container. Also attachment to the other structural part of the sensor structure 102a, such as carrier element 110, electrodes 108, or any part physically connectable thereto, may be optionally realized. The exemplary process for assembling the sensor structure 102a may thus comprise applying an adhesive onto a rib surface of the cover element 112 adapted to contact elements 106, 108 and/or a rib surface of the carrier element 110, respectively (FIG. 1A), in order to hold these elements and to enable and/or to facilitate a contact between the film 106 and the electrodes 108, and mechanical pressing elements 112 and 110 together.

The cantilever element 118 may damper an impact caused by acceleration, radiation and/or other mechanical or energy impact. The element 118 may also act as a holder for the mass element 104, which is, when released from mechanical contact to carrier and/or cover elements 110, 112, triggers transition of the sensor structure 102a into activated state.

The sensor structure 102a may be realized with the mass element 104 being disposed and/or attached to an either face of the support element 106, i.e. fronting either the cover element 112 or the carrier element 110.

Signals from the electrodes 108 may be directly or via intermediate elements received by electrical or optical conductors or in a wireless mode by the element 116, represented by a microcontroller, optical transmitter, RF-transmitter and the like, that element 116 is adapted to determine the value to be measured, such as e.g. resistance.

Variations of the free-standing film comprising embodiment of the sensor structure are illustrated by 102b-102i (FIG. 1B). For clarity purposes cover 112 is not shown. Mass element 104 may take various shapes, sizes and locations in accordance with technical requirements and particular implementation mode.

At the top view 102b, a preferred version of the embodiment with free-standing film 106, comprising also a substantially spherical mass element 104, two electrodes 108 and two carrier elements 110 located at the opposing edges of the film 106 is shown. It is to be understood, however, that the shape the mass element 104 may be arbitrary. In accordance to 102b, the film 106 is extended in space between two electrodes 108 while being fixed on said electrodes (the part of electrodes 108 hidden below the film 106 is shown in dashed line).

At the top view 102c, one version of the embodiment substantially similar to that of 102b is shown, wherein film 104 extends the borders of the electrodes 108.

At the top views 102d and 102e, a film 106 is extended over a space between electrodes 108, positioned in turn at the opposite edges of the frame formed by the carrier element 110, implemented herein as a box. The electrodes 108 are thus positioned substantially at the edges of the box and the film 106 is disposed between electrodes, while being fixed onto either of them. In case of 102e the film 106 substantially covers almost the whole carrier element 110, realized herein as a box, and electrodes 108. The inner edge of frame of the carrier element 110 is shown herein in dashed line, so are electrodes 108. Dashed line is indicative of that said elements are hidden below the film 106.

At the top view of 102f a substantially rectangular film 106 is disposed between the electrodes 108 over a space formed by the edges of the cylindrical box-like element 110. 102f is thus indicative of that the element 110 may take various shapes, although the film 106 may stay substantially rectangular.

At the top view of 102g a substantially circle-shaped film 106 is disposed between the electrodes 108. The number of the electrodes 108 in this case may be substantially any number equal-to-or-greater-than two. The film 106 is arranged herein to cover the space formed by the edges of the cylindrical box-like element 110. The bottom of the element 110 is shown in dashed line.

At the top view 102h a film 106 with at least one slot 120 defined by the film contour, optionally with e.g. two symmetrically located slots (relative to a reference point such as the geographical and/or mass center of the film and/or mass element 104), for facilitated and/or otherwise controlled fracture is shown. The slots 120 or other predetermined fracture-affecting features typically defined by the film material edges may indeed be located close to the mass element 104, for instance. Carrier element is denoted by 110, and the electrodes are denoted by 108.

At the top view 102i, an asymmetrical film 106 (upper left corner missing from complete rectangle) is applied to obtain desired properties in view of dimensional fracture sensitivity, for example. Also the mass element 104 may be asymmetric, which is alluded in the figure via the element shape as well. Electrical conductors are denoted by 108; carrier element 110 is not shown. The film 106 is provided by a number of fracture-affecting features, essentially cracks or cuts 120, which may be mutually different regarding e.g. orientation and/or size thereof.

The different features, elements, element configurations, dimensions, fracture-affecting elements, shapes etc. discussed above may be naturally cleverly combined by a skilled person to come up with new variations of the same basic embodiment.

Referring now back to 102a (FIG. 1A), mass element 104 may optionally have a removable attachment substantially to any structural part of the sensor structure 102a, physically connectable thereto, such as the element 110, realized either as individual support structures or as a box, the cover 112 or the electrodes 108. Other supplementary parts for the attachment of the mass element 104 may include additional electric conductors (not on the figure), wherein a current may be induced for releasing the mass element 104 off physical attachment, an event, leading in turn to sensor activation. Mass element release event may be implemented also by means of physical melting of the fixing substance, by magnetic- or RF-fields or by optically induced effect, wherein the strong enough light may change mechanical properties of said attachment (which may have configuration similar to the element 118) by melting or burning. Optionally, the mass element 104 may be fixed to the other structural part of the sensor structure than the film 106, for example, to the element 110, in such a way, that it may be released later by various means, such as melting, electrical current, magnetic field, radiation, optical beam, so that the sensor structure will be in an active operational mode during assembly, delivery or usage of the item, said sensor structure is embedded thereto.

Mass element 104 may be adapted to possess magnetic properties and to be attracted to magnets or ferromagnetic metals in order to be able to detect essential changes in magnetic field or physical approaching of a ferromagnetic material. Magnetic mass element 104 may compel the sensor structure to function as a magnetic fuse instead, or in addition to said sensor's ability to detect mechanical acceleration. The forces, that may affect an item, the sensor structure with the mass element 104 possessing magnetic properties is embedded thereto, may be induced, for example, by an excessive magnetic- or RF-fields resulting from a malfunction in some part of the item wherein said sensor is being used. For example, a damaged component of an electronic device, such as e.g. a cell phone, may induce a high current flow through an inductor causing a generation of strong magnetic field, thereupon the mass element 104 is forced to move, film 106 is thus caused to break and an electronic device is consequently turned off. Above mentioned forces may be further induced by an intentional transfer of a magnet or ferromagnetic material into close proximity to the sensor structure, or by a high magnetic field.

Above disclosed sensor structure may also operate as an optical or radiation sensor, wherein an optical effect or radiation is tuned to permanently alter or break the support element (film) 106 either in presence or in absence of mass element 104. For example, an increased optical radiation can be focused by means of lens 122 (herein, disposed into the cover 112, optionally may be external) or other optically functional element(s) on the film 106 or on mass element 104 positioned onto the film, in order to cause measurable changes in the film. This change is preferably permanent and may be induced while either the sensor is read or is not. In another example, the film 106 may contain ferromagnetic particles that provide said film with sensitivity ferromagnetic field. Whether it is the case, the mass element 104 may be omitted from the sensor structure. The fracture of the film thus occurs when magnetic field affects ferromagnetic particles in the film.

Generally, in response to the physical stress induced by the mass element to the film and depending on the location and direction of the related forces and the configuration of the film itself, the nanotube material, which may be brittle or become brittle, may, in the case of excessive acceleration forces, fracture and/or crush permanently. Less radical forces, e.g. far below 10% of load threshold value may just cause a temporary change in resistance and stretch the film, however when the load is small the film returns to or close to the initial position.

The electrically measurable parameter(s) may reflect the current and optionally historical status of the film and thus indicate the nature of the acceleration events experienced by the sensor. Parameter changes essentially occur while the sensor is not read. For example, permanent increase in resistance or other electrical parameters may indicate the breakage of the film and associated nanotube structure. Temporary fluctuations may result from minor acceleration not causing permanent changes in the nanotube structure. Depending on the applied sensor structure configuration, acceleration in selected directions only, such as in film height direction, may more noticeably affect the film and be thus more easily measurable. To properly cover additional directions, multiple sensor structures with different orientation and/or alignment may be utilized in the same use scenario.

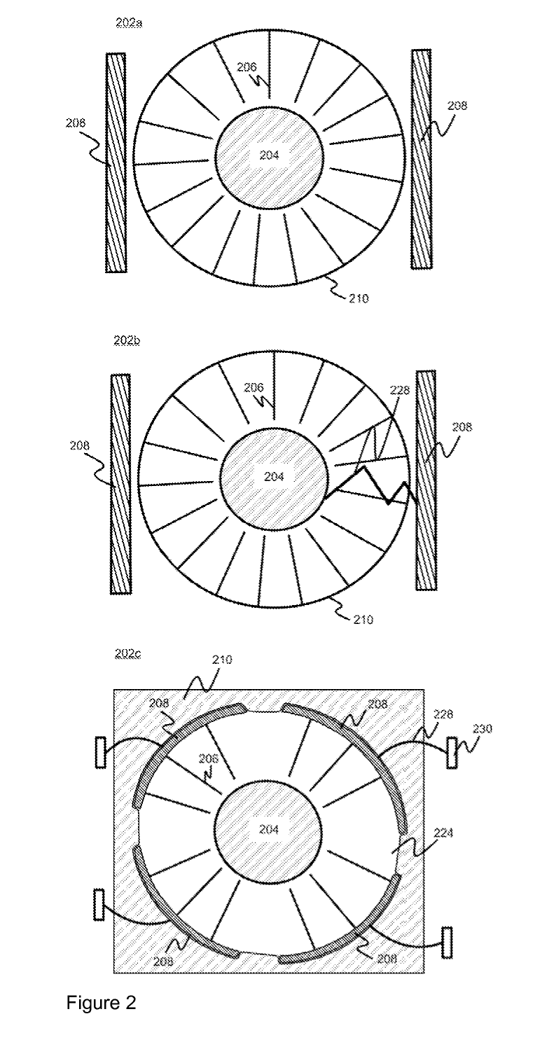

FIG. 2 illustrates a second embodiment of the invention it its variations, intended for a sensor with an equal sensitivity in x, y and z directions. By this embodiment more precise three-dimensional sensing capacity may be provided.

At 202a, representing a sectional cut top view, a sensor structure is disclosed, wherein inside a carrier structure, represented by a substantially closed, hollow, preferably spherical element 210, a substantially spherical mass element 204 is positioned. Mass element 204 forms the ‘core’ being supported by tubular nanostructures 206, preferably nanotubes, still preferably carbon nanotubes, extending from the inner surface of the carrier element 210 towards the core. Said nanotubes are manufactured for example by grown on the substrate (e.g. silicon) disposed on the inner surface of the spherical carrier 210 forming a nanotube forest surrounding the mass element. Said nanostructures together with the substrate disposed on the inner surface of the carrier 210 are referred herein as a support element 206 for the mass element 204. Alternatively or additionally, the mass element 204 may be provided with the nanotubes; the nanotubes may be grown on the mass element's surface. An optional wire or string 228 may be arranged to provide connection between mass element 204 and electrical conductors 208, such as electrodes, as illustrated by 202b. Sensor structure of the second embodiment comprises at least one electrical conductor. Electrical conductors 208 may either be brought into a direct contact to the carrier element 210, or stay close to it without contacting its surface. The element 228 may be configured to damper an impact caused by acceleration, radiation and/or other mechanical or energy impact, and therefore to act as a holder for the mass element 204, which triggers an activation of the sensor structure when being released from mechanical contact to members 208, and optionally 210.

Upon acceleration, the mass element 204 and the carrier element 210 induce external forces on the nanotube forest that may then at least partially collapse, i.e. the nanotubes may break and/or otherwise change in configuration due to the subjected stress.

More radical the acceleration is, more changes typically occur in the nanostructure. The changes may be temporary when the acceleration is mild enough, i.e. below the nano-material structural durability threshold. A number of electrical sensors or sensor-connected electrodes 208 may be applied to measure the associated electrical response in terms of e.g. resistance, capacitance or inductance.

Sensor structure 202a illustrates the case when the measurable variables are impedance and capacitance. In order to perform resistance measurements, the conductor 208 is to be physically connected to the mass element. The exemplary variation of spherical sensor structure embodiment for detecting changes in resistance, impedance, capacitance or inductance is represented by 202b, wherein the connection between the mass element 204 and one of the electrodes 208 is realized by at least one electrical connector 228, such as a wire, for example. Electrical connector(s) 228 may be arranged to penetrate the carrier element 210.

Another variation of the second embodiment is illustrated by 202c and represents an essentially three-dimensional symmetrical sectional cut top view of the sensor structure comprising a substantially closed, hollow, carrier element 210, provided with at least one carrier element spacing 224 (herein, four), the support element 206, comprising a forest of tubular nanostructures grown on an inner surface of the carrier element 210, as described above, the electrical conductors 208, such as electrodes, and the mass element 204. The nanostructures 206 are substantially arranged to grow on conductors 208, but may be also grown onto spacing elements 224.

At least one electrical connector 228, such as a wire, is arranged at the carrier element 210 (herein, four), said connectors leading to elements 230, defined herein as contact leads and adapted to physically attach the sensor structure of 202c to a device or container, wherein the sensor is supposed to be utilized. Electrical conductor element(s) 208 in configuration of 202c are arranged to be coupled to elements 230 by means of electrical connectors 228. Unlike in case of 202a, wherein mass element 204 is not in a direct electrical contact with electrical conductors 208, herein an electrical measurement is implemented while electrical conductor elements are physically connected the mass element.

In 202a, b and c alternatively or additionally, the mass element 204 may be provided with the nanostructures that may be grown on the surface of the mass element. Alternatively or additionally said nanostructures may be arranged into a nanomaterial further dispensed in between the mass element 204 and the carrier element 210 by any suitable means. The mass element 204 may be provided with mentioned nanomaterial wrapped around thereof.

The preferred materials for manufacturing cover and carrier elements 110, 112, 210 in accordance with both embodiments may comprise polymers, polymeric composites, silicon, PCB (printed circuit board), or ceramics. Consequently, a skilled person may use many other known solid dielectric materials for this purpose.

Sensor structure of either embodiment of present invention may be preferably connected to a wireless readout device, such as RFID, for example.

The sensor structure in accordance to any embodiment may be utilized in RFID tags, such as RFID stickers, for example. The sensor enables detection of contact break(s) in antenna, related circuitry, power or sensor conductors. Most effective way of manufacturing an RFID sticker of a kind is to form (e.g. by molding, heat forming, embossing forming) the plastic frame of the sticker so, that it will comprise a small cavity for the mass element 104 to move within. The film 106 may be placed over the frame and the cavity. The electrode 108, preferably positioned over the film 106, may therefore be represented by the parts of an RFID sticker conductor or an antenna.

Sensor structure of either embodiment of present invention may be utilized as a flow metering device for fluids, wherein fluid is arranged to flow aside, around or through the nanostructure-comprising support element 106, 206, which device enables monitoring and measuring of flow parameters for fluids correspondingly by measuring changes in the resistance and/or breaking contacts when the threshold value is exceeded. Correspondingly the element 122 (FIG. 1A) may be provided as an elastic or plastic member, which physically presses and breaks the film 106 when exceeding a certain threshold pressure is applied thereto. Such configuration may be realized even in an absence of the mass element 104.

Consequently, a skilled person may on the basis of this disclosure and general knowledge apply the provided teachings in order to implement the scope of the present invention as defined by the appended claims in each particular use case with necessary modifications, deletions, and additions. The fulcrum will substantially remain the same. The mutually exerted, acceleration-based, forces between the mass and support elements also have a grasp of, i.e. they reach and affect the associated nanotube structure that then undergoes a change in physical configuration that is measurable electrically.

1. A sensor structure (102a, 102b, 102c, 102d, 102e, 102f, 102g, 102h, 102i, 202a, 202b, 202c) preferably omitting the requirements of powering and/or continuous monitoring while detecting and measuring the effects of physical inputs, said sensor structure comprising:
a mass element (104, 204);
a support element (106, 206) for the mass element, comprising a plurality of substantially tubular nanostructures, optionally carbon nanotubes, arrangement of said nanotubes is preferably random,
wherein
the mass element and support element are configured such that upon acceleration, and/or other mechanical, radiation-, magnetic- or other energy impact, exceeding a predetermined threshold, a permanent physical damage takes place in the physical configuration of the nanostructures, such as altering, fracturing or breaking, inducing a change in a measurable value of a predetermined electrical parameter, said electrical parameter optionally including or indicating at least one electrical property selected from the group consisting of: resistance, inductance, impedance and capacitance.

2. The sensor structure of claim 1, further comprising a number of electrical conductors (108, 208), such as electrodes, functionally coupled to the support element (106, 206) for enabling electrically measuring the change, further optionally comprising a measurement entity (116) configured to measure the electrical value utilizing a signal provided by the conductors.

3. The sensor structure of claim 1, further comprising a number of optical connectors, such as optical wave guides, functionally coupled to the support element (106, 206).

4. The sensor structure of claim 1, further comprising at least one carrier element (110, 210), configured to support and preferably secure the support element (106, 206) from a number of edges or edge areas thereof, optionally substantially along the entire circumference of the film, and to define an internal space of the sensor structure.

5. The sensor structure of claim 1, wherein the support element comprises of a free-standing film (106, 114) for accommodating the mass element, which is functionally coupled to a number of the electric conductors (108, 208) or optical connectors, from the edges or edge areas along the whole circumference or at least from a number of selected points such as two optionally opposing points in such a way, that the freestanding film (106, 114) is disposed in the air, gas, a mixture thereof and/or other medium, such as vacuum, in between two electrodes without additional substrate.

6. The sensor structure of claim 5, wherein the freestanding film (106, 114) comprises substantially unoriented nanotubes.

7. The sensor structure of claim 6, wherein the freestanding film (106, 114) comprises substantially unoriented carbon nanotubes.

8. The sensor structure of claim 5, wherein the film comprises a number of predetermined fracture points, areas or volumes (120) to control and/or facilitate said permanent change taking place, said points, areas or volumes optionally including at least one element selected from the group consisting of: a crack defined by the film material, a slot defined by the film material, a hole or recess defined by the film material, a protrusion defined by the film material, a thinned portion of the film, a narrowing of the film, and a cut defined by the film material.

9. The sensor structure of claim 1, wherein the carrier element (210) and the support element (206) are adjusted to acquire a substantially closed, hollow, preferably spherical shell structure, whereinto the mass element (204) is disposed.

10. The sensor structure of claim 9, the support element comprising the tubular nanostructures (206), said nanostructures extending towards the mass element (204).

11. The sensor structure of claim 9, the carbon nanostructures being grown on the surface of the mass element (204) and extending towards the carrier element (210).

12. The sensor structure of claim 1, said sensor structure comprising a support element (106, 206), manufactured from a substantially solid, electrically conductive or semi-conductive film, or optical wave guide material.

13. The sensor structure of claim 1, wherein the support element (106, 206) is configured such, that upon radiation, such as high intensity light, or upon a high magnetic field, exceeding a predetermined threshold, a permanent physical damage takes place in the physical configuration of the nanostructures, such as altering, fracturing or breaking.

14. The sensor structure of claim 13, wherein an optical effect or radiation is tuned to permanently alter or break the support element (106, 206) either in presence or in absence of mass element (104).

15. The sensor structure of claim 1, wherein the support element (106, 206) comprises a film formed from substantially non-tubular materials like sheet(s), such as sheet(s) of graphene or any suitable solid or amorphous matter capable of forming a freestanding film.

16. The sensor structure of claim 1, which mechanical and/or absorption properties can be altered by applying material, such as coating, onto the support element (106, 206) and/or by removing that material from the support element (106, 206).
